(19) United States
(12) Patent Application Publication
(10) Pub. No.: US 2009/0155586 A1
(43) Pub. Date: Jun. 18, 2009

(54) Method of Improving Skin Appearance Using Treated Macroscopic Particles

(75) Inventors: Prithwiraj Maitra, Randolph, NH (US); John C. Brahms, Morris Plains, NJ (US); John R. Glynn, JR., Ridgewood, NJ (US); Michael J. Fair, Ridgewood, NJ (US); Steven E. Brown, New Windsor, NY (US)

Correspondence Address: AVON PRODUCTS, INC., AVON PLACE, SUFFERN, NY, 10901, US

(73) Assignee: Avon Products, Inc., New York, NY (US)

(21) Appl. No.: 11/954,389

(22) Filed: Dec. 12, 2007

(51) Int. Cl. B32B 5/16; B32B 7/02; B05D 7/00

(52) U.S. Cl. 428/338; 428/403; 428/404; 427/212

(57) ABSTRACT

The invention relates to topical compositions comprising inorganic particles coated or embedded on the surface of macroscopic particles, methods of preparing the compositions, and uses thereof. The topical composition may be delivered and applied to a surface, thereby improving the appearance of the surface. This composition can reduce the visibility of textural imperfections, such as fine lines, wrinkles, and scars, as well as color imperfections, such as age spots and blemishes. The treatment of inorganic particles on the surface of macroscopic particles can be achieved by three methods, including mechanofusion, physical adsorption, and pre-emulsification into macroscopic particles. This invention also relates to methods of using the composition in a cosmetic or dermatological application, as well as, in an industrial application.

### FIELD OF THE INVENTION

This invention relates to compositions comprising macroscopic particles surface-treated with inorganic particles, methods of preparing the compositions by embedding inorganic particles on the macroscopic particles forming surface-treated macroscopic materials, and methods of use thereof.

### BACKGROUND OF THE INVENTION

In cosmetics, there is oftentimes a trade-off in the ability to hide skin imperfections while simultaneously producing a natural appearance. Commonly, cosmetic applications employ soft-focus macroscopic materials and inorganic particles such as pigments and fractal particles. The high-opacity pigments tend to obscure skin imperfections, such as blemishes, and soft-focus materials generally blur fine lines and wrinkles. However, if the inorganic particles are too densely packed, they become visible against the background of the soft-focus materials and user's skin tone, which makes the application look artificial.

Some cosmetics use inorganic particles physically blended with macroscopic particles such as elastomers and crosspolymers to alleviate some of these problems. The macroscopic particles help to prevent the dense packing of inorganic particles by providing a physical barrier between inorganic particles within the application. These combinations yield other benefits as the macroscopic particles provide both structure to the application and a smooth feel to the consumer.

The combination of inorganic particles and macroscopic particles in cosmetic compositions is well known to those skilled in the art. For example, the prior art includes U.S. Pat. No. 6,258,345 B1, U.S. Pat. No. 6,475,500 B2, and WO 03/080005A1. These describe a physical blend of cross-linked elastomeric organopolysiloxane with spherical polymeric particles with particle diameter of 10 microns, a physical blend of cross-linked siloxane elastomer with pigments, and a three-dimensional personal care composition.

However, these and other physical blends tend to result in compositions that accentuate skin imperfections. For instance, the inorganic particles tend to migrate on the skin and accumulate into pores, fine lines, and wrinkles. This dense packing of inorganic particles makes them more visible, both highlighting the skin imperfections and offsetting the skin tone neutralizations by soft-focus materials. Finally, since the pigments tend to backscatter light, it creates an unnatural and cakey appearance. Thus, there is a need to find the optimal balance of employing inorganic particles, such as high-opacity pigments, with soft-focus materials to obscure both textural and color imperfections on skin, as well as, to produce a natural appearance.

### SUMMARY OF THE INVENTION

Embodiments of the invention relate to a composition of macroscopic particles surface-treated with inorganic particles forming a surface-treated macroscopic material, methods of preparing the composition, and methods of use thereof.

One embodiment of the invention is directed to a composition comprising at least one inorganic particle, preferably multiple inorganic particles, embedded on the surface of a macroscopic particle or multiple macroscopic particles, thereby forming a surface-treated macroscopic material. The surface-treated macroscopic material has a macroscopic particle surface embedded with inorganic particles and a core comprising the macroscopic particle free of inorganic particles. It is useful to have a refractive index of the inorganic-treated macroscopic particle surface greater than the refractive index of the core of the macroscopic particle.

Other embodiments of the invention are directed to methods of preparing a composition comprising the surface-treated macroscopic material. These methods include a method of embedding inorganic particles on the surface of a macroscopic particle by mechanofusion, physical adsorption, and pre-emulsification into a surface treated macroscopic material.

A further embodiment of the invention is a method for improving the appearance of surfaces by applying the composition of the invention. The inventive composition comprising a macroscopic material surface-coated with inorganic particles is useful for improving the appearance of surfaces due to the invention's properties, including, but not limited to, reflectance, diffused transmittance, and securely embedded inorganic particles on the macroscopic particle surface.

### BRIEF DESCRIPTION OF THE DRAWINGS

FIG. 1 shows an optical micrograph of aggregates of pigments that are approximately 1-10 microns in diameter. (400× magnification).

FIG. 2 shows an optical micrograph of macroscopic particles surface-coated with pigment particles approximately 20-50 microns in diameter where the treatment is by the mechanofusion method. (400× magnification).

FIG. 3 shows the percent increase in diffused transmittance of a film of pigment surface-treated macroscopic materials compared with that of an untreated macroscopic particle control, where the film has an average thickness of 10 microns.

### DETAILED DESCRIPTION OF THE INVENTION

In accordance with the foregoing objectives and others detailed herein, embodiments of the invention overcome deficiencies associated with the prior art by providing compositions comprising a surface-treated macroscopic material which improves the aesthetic appearance of a surface such as, for example. skin resulting from, for example, the chronological aging process, acne, or damage to the surface. The composition and methods thereof, once applied to a surface, such as a biological surface or synthetic biological surface, provide the appearance of rejuvenated or enhanced surfaces by providing coverage and optical blurring.

Embodiments of the invention generally relate to a composition of a macroscopic particle and an inorganic particle which form a surface-treated macroscopic material, a method of preparing the composition or for surface-treating a macroscopic particle with an inorganic particle forming a surface-treated macroscopic material, and uses thereof.

The composition of the surface-treated macroscopic particle that may be applied onto surfaces, including but not limited to, biological surfaces, synthetic biological surfaces, or keratinous surfaces such as, the skin, hair, or nails. This composition may be used in a cosmetic or dermatological application and may reduce the visibility of textural imperfections, such as fine lines, wrinkles, and blemishes, as well as color imperfections, such as, for example, age spots and scars from acne or injury. In a further embodiment, the composition may be used in an industrial capacity for paints useful for providing coverage and an overall enhanced appearance on uneven or damaged surfaces.

One embodiment of the invention relates to a composition of the surface-treated macroscopic particles. The macroscopic particles may be treated with inorganic particles, for example, but not limited to, pigments, micron-sized pigments, fractal particles, or the like, or combinations thereof. The macroscopic particles may be treated by embedding inorganic particles onto the surface of the macroscopic particles. In a specific embodiment, hard inorganic particles are embedded onto the surface of soft macroscopic particles. The embedded inorganic particle refers to an inorganic particle that is either partly or completely enclosed by the macroscopic particle, but essentially remains on the surface of the macroscopic particle. The macroscopic particle surface embedded with inorganic particles should have a higher refractive index relative to the core of the macroscopic particle which is free of any inorganic particles.

Non-limiting examples of macroscopic particles are silicone elastomers, hydrocarbon elastomers, silicone crosspolymers, or combinations thereof. In one preferred embodiment of the invention, the macroscopic particles are elastomeric particles. In another preferred embodiment the macroscopic particles are silicone crosspolymers. The preferred particle size of the macroscopic particles range from about 1 to about 200 microns. More useful macroscopic particles may have a diameter of about 1 to about 50 microns. Generally, the macroscopic particle is larger than the inorganic particles.

In one embodiment, an inorganic particle is embedded or coated on the surface of the elastomeric particle thereby forming a surface-treated macroscopic material. As used herein, illustrative, non-limiting examples of macroscopic elastomeric particles to which this embodiment may be applied are natural and synthetic rubbers, for example, natural rubber, nitrile rubbers, hydrogenated nitrile rubbers, ethylene-propylene rubbers, polybutadiene, polyisobutylene, butyl rubber, halogenated butyl rubber, polymers of substituted butadienes. such as chlorobutadiene and isoprene, copolymers of vinyl acetate and ethylene terpolymers of ethylene, propylene, and a non-conjugated diene, and copolymers of butadiene with one or more polymerizable ethylenically unsaturated monomers such as styrene, acrylonitrile, and methyl methacrylate; silicone elastomers; fluoropolymers including fluoropolymers having a silicone backbone; polyacrylates; polyesters, polyacrylic esters, polyethers; polyamides, polyesteramides, polyurethanes, and mixtures thereof. Moreover, it is understood that the macroscopic particle may contain additional organic or inorganic phases to modify the optical properties of the particle, such as for example, refractive index.

In a further embodiment of the invention which utilizes elastomeric particles, silicone elastomers, for example, may be (i) cross-linked silicone polymers derived from room temperature vulcanizable silicone sealant chemistry, or (ii) addition polymerized silicone elastomers prepared by the hydrosilylation of olefins or olefinic silicones with silyl hydrides. Skilled artisans understand hot to obtain these silicone elastomers. Non-limiting examples of silicone elastomers include crosslinked organopolysiloxanes such as, for example, dimethicone/vinyl dimethicone crosspolymers, vinyl dimethicone/lauryl dimethicone crosspolymers, alkyl ceteayl dimethicone/polycyclohexane oxide crosspolymers, or mixtures thereof Non-limiting examples of these elastomers include: cyclopentasiloxane (and) Dimethicone Crosspolymer: DC 9040 and DC 9045 commercially available from Dow Corning® (Midland, Mich.), dimethicone/phenyl vinyl dimethicone crosspolymers, specifically, cross-linked methylpolysiloxanes under the tradenames KSG-15 (in decamethyl cyclopentasiloxane); KSG-16 (in low-viscosity methylpolysiloxane); and KSG-18 (in methylphenyl polysiloxane) commercially available from Shin Etsu Silicones of America, Inc. (Akron, Ohio); lauryl dimethicone/vinyl dimethicone crosspolymers supplied by Shin Etsu Silicones of America, Inc. (Akron, Ohio) (e.g., KSG-31 (lauryl dimethicone/copolyol crosspolymer), KSG32; vinyl dimethicone/lauryl dimethicone crosspolymers (KSG-41 in mineral oil; KSG-42 in isododecane; KSG-43 in triethylhexanoin; and KSG-44 in squalane), and the Gransil line of elastomers available from Grant Industries Inc. (Elmwood Park, N.J.) such as Dimethicone/Divinyldimethicone/Silsesquioxane Crosspolymer under tradename, EPSQ™. An embodiment of the invention utilizes a preferred silicone elastomer of EPSQ™.

Also suitable in embodiments of the invention are silicone crosspolymers obtained by self polymerization of bifunctional precursor molecules containing both epoxy-silicone and silyl hydride functionalities to provide a silicone copolymer network in the absence of crosslinker molecules. Especially suitable are such crosspolymers such as the Velvesil™ line of silicone crosspolymers available from Momentive Performance Materials, Inc. (Wilton, Conn.; formerly GE Silicones). Preferred crosspolymers for embodiments of the invention include SFE 839™ (cyclomethicone (and) dimethicone/vinyldimethicone crosspolymer) and VELVESIL™ (cyclopentasiloxane (and) C30-45 alkyl dimethicone/polycyclohexene oxide crosspolymer), most preferably the VELVESIL™ 125.

Such macroscopic particles are prepared by conventional procedures, for example, by palletizing, cutting, or tearing a bale of the macroscopic material into shreds or small pieces followed by chopping or grinding those shreds or small pieces into particles having the desired size. In addition “wet” chemistry techniques known in the art may be used to form macroscopic particles of a particular size or distribution of particle sizes that are desirable. The practice of the present invention does not depend on the particular procedure utilized to prepare the macroscopic particles.

Suitable inorganic particles used to modify the surface of the macroscopic particle include, but are not limited to, pigments, fractal particles, mixtures thereof, and the like. Such inorganic particles include metal oxide particles such as, for example, nano-sized and/or micron-sized iron oxide pigments, fractal particles, mixtures thereof, and the like. In addition, inorganic particles may be comprised of a single metal oxide type or mixtures of at least two different metal oxide types, such as, but not limited to, aluminosilicates and the like. Other types of inorganic particles may be used such as sub-oxides, nitrides, carbides, and the like. Preferably, the refractive index of the inorganic particles is greater than the refractive index of the macroscopic particle. The ratio of the refractive index of the surface of the macroscopic particle embedded with inorganic particles to the refractive index of the macroscopic particle core ranges from about 1.02 to about 2.50, preferably between about 1.07 to about 2.40, and most preferably between about 1.10 to about 2.20.

The inorganic particles are preferably sub-micron-sized, ranging in size from about 0.05 to about 5 microns. A preferred size range for pigments is about 0.5 microns to about 3 microns. Whereas, a preferred size range for fractal particles is about 0.05 to about 1 micron. Another embodiment of the invention includes a composition of macroscopic particles with other similar inorganic particles that one skilled in the art would find useful in coating or treating macroscopic particles. The ratio of the diameters of the macroscopic particle to that of the inorganic particle is between about 1 to about 1000, more preferably about 10 to about 100 and most preferably between about 20 to about 50. The preferred ranges should enable a close packed arrangement of the inorganic particles in the surface of the macroscopic particle.

A pigment is a solid that reflects light of certain wavelengths while absorbing light of other wavelengths, without providing appreciable luminescence. Micron-sized pigments are useful inorganic particles, and include such pigments that have a diameter of about 0.05 to about 10 microns. In one embodiment of the invention, the pigments that are embedded on the surface of macroscopic particles have a diameter of about 0.1 to about 5 microns. A single pigment type, or combinations or blends thereof, may be used, in surface treating the macroscopic particle to form a surface-treated macroscopic material. Pigments may be used to impart opacity and color to the cosmetic compositions herein. Any pigment that is generally recognized as safe (such as those listed in the International Cosmetic Dictionary and Handbook, 11th Ed., Cosmetic, Toiletry & Fragrance Association, United States, Washington, D.C., (2006), herein incorporated by reference) may be used with the macroscopic particles herein. Useful pigments include body pigment, inorganic white pigment, inorganic colored pigment, pearling agent, and the like. Specific examples include, but are not limited to, talc, mica, magnesium carbonate, calcium carbonate, magnesium silicate, aluminum magnesium silicate, silica, titanium dioxide, zinc oxide, red iron oxide, yellow iron oxide, black iron oxide, ultramarine, titanated mica, iron oxide titanated mica, bismuth oxychloride, and the like. These pigments and pigmented powders can be used independently or in combination in order to provide the best coverage and/or color. In a preferred embodiment, the pigments are titanium dioxide, iron oxides, and mixtures thereof.

Another inorganic particle useful in surface treating the macroscopic particle is a fractal particle which includes irregularly shaped particles, or combinations thereof, that are micron-sized and approximately 0.05 to about 10 microns, and preferably about 0.1 to about 5 microns. The fractal particles may be used alone or in combination with other fractal particles, pigments, or other inorganic particles which demonstrate the appropriate characteristics desired not only in the inventive composition, but also in the inventive methods of surface-treating macroscopic particles and surface-treated macroscopic materials for use in, for example, cosmetic or dermatological applications. Examples of suitable fractal particles include, those that are physiologically compatible, but are not limited to, fumed silicas, including hydrophilic and hydrophobic fumed silicas, colloidal silica, fumed titania, fumed alumina, fumed ceria, fumed indium tin oxide, fumed zirconium oxide, and fumed zinc oxide. Non-limiting examples of such fractal particles include, such products as those sold by Degussa (Parsippany, N.J.) under the tradenames AEROSIL® fumed silica, the AEROSIL® R-900 series, A380™, OX50™, and ADNANO®, ADVANCED NANOPARTICLES™ and such products as those sold by Cabot Corporation (Boston, Mass.) under the tradenames CAB-O-SIL® and SPECTRAL™.

The weight ratio of the inorganic particles to macroscopic particles is typically from about 1:10 to about 10:1, preferably from about 1:8 to about 5:1, and most preferably from about 1:5 to 1:1.

The presence of branched fractal networks on the surface of macroscopic particles improves both forward and lateral scattering of light and produces high levels of back scattering light which imparts a desirable optical effect on a surface. Desired optical effects are defined as visually improving the appearance of, for example, skin by imparting even skin tone and color, visually reducing redness, age spots, scars, pores, fine lines, wrinkles, and skin imperfections without producing an unnatural whitening appearance. Cosmetic products that have desired optical properties produce natural, youthful appearance of the skin. Cosmetic compositions containing macroscopic particles coated with inorganic particles may be formulated as, but not limited to, a pressed powder, foundation base, or a non-pigmented gel. These compositions are also useful in producing desired optical effects on any surface, including, for example, automotive body parts, siding, etc.

A further embodiment of the invention relates to a composition having a macroscopic material having a core region free of inorganic particulates, or essentially free, and a surface region on which inorganic particles are embedded. The refractive indices of the core and the surface on which inorganic particles are embedded are not similar. The surface of the surface-treated macroscopic particle has a refractive index greater than the refractive index of the core.

In one embodiment of the invention, the composition contains inorganic particles embedded on the surface of the macroscopic particles, where the refractive index of the surface of the surface-treated material is greater than that of its core. The refractive indices of various materials may be obtained by using a refractometer or by calculating a volume-weighted average of each type of material, both of which are commonly used and understood methods. Refractive indices of materials may be found in such reference books as, but not limited to, the CRC Handbook of Chemistry and Physics, David R. Lide (ed.), 87th Edition, CRC Press, Taylor & Francis Group, United States, Boca Raton, Fla., (2006), herein incorporated by reference. High refractive indices are capable of scattering visible light and are thereby useful in cosmetic compositions that hide, camouflage, or cover creases, wrinkles, fine lines, or imperfections of surfaces.

One embodiment uses suitable refractive indices of the macroscopic particle ranging from about 1.30 to about 1.60 while the refractive indices of the surface of macroscopic particles surface-treated with inorganic particles may be from about 1.40 to about 3.50. In a further embodiment of the invention, the macroscopic particle core is a silicone elastomer having a refractive index of about 1.43 where the silicone elastomer is free of inorganic particles, while the refractive index of the surface of a surface-treated macroscopic material having TiO₂ embedded on the surface of the silicone elastomer is 2.6. The ratio of the refractive index of the TiO₂-treated silicone elastomer surface to the refractive index of the silicone elastomer core free of TiO₂ particles is 1.8. Thus, the ratio of refractive index of the surface of the surface-treated macroscopic material to the refractive index of the core is greater than 1. Non-limiting ranges of the ratio of the refractive index of the surface of a surface-treated macroscopic particle to the refractive index of the macroscopic particle core free of inorganic particles include ranges of about 1.02 to about 2.50, preferably between about 1.07 to about 2.40, and most preferably between about 1.10 to about 2.20.

Attachment of inorganic particles to the surface of the macroscopic particle may be achieved by methods that use, but are not limited to, mechanical energy, such as, for example, milling, chemical reactions and polymerizations, and physico-chemical interactions such as, but not limited to, adsorption. Preferably, methods that rely on mechanical energy (milling) to embed the inorganic particle into the surface of the macroscopic particle have been found to be particularly useful. Embedding the inorganic particle into the surface of the macroscopic particle requires the mechanical hardness of the inorganic particle to be at least equal to, or greater than the hardness of the macroscopic particle.

Hardness refers to a material that has a resistance to local penetration, scratching, deformation, machining, wear or abrasion, and yielding. Hardness of a material may be measured by various methods. Non-limiting examples of methods for determining hardness include, but are not limited to, the: Rockwell Hardness Test, Brinell hardness test, Vickers Hardness Test, Knoop Hardness Test, and the Shore method, and each method depends on the type of hardness measured, i.e., the macro-, micro-, or nano-scale. Reference books, such as but not limited to the Encyclopedia of Polymer Science and Technology (Interscience Publishers of John Wiley & Sons, Inc., New York, Vol. 7, at 470-478 (1967), herein incorporated by reference), are available for one skilled in the art to define, quantify, and measure hardness for selecting the appropriate macroscopic and inorganic particles useful in various embodiments of the invention.

There are country-specific standards for material hardness, such as the American Society for Testing and Materials (ASTM) and the Japanese Industrial Standard (JIS). A person skilled in the art can accordingly select the appropriate material, both macroscopic particle and inorganic particle, based on the knowledge that the skilled artisan possesses and information commonly known in the art. Reference books, readily available, such as but not limited to, the JIS Yearbook-2006 (JSA (Ed); Published by JSA; ISBN:4-542-17390-19; herein incorporated by reference) are useful for selecting materials with the appropriate characteristics such as, for example, hardness, for the preparation of the composition described herein. A hard inorganic particle refers to an inorganic particle where its Japanese Industrial Standard (JIS) A value is about 90 or greater. As used herein, a soft macroscopic particle refers to a particle where its JIS A value is less than about 90.

In one embodiment, the inventive composition is prepared by a method of treating dry macroscopic particles with inorganic particles such as pigments or fractal particles using a mechanofusion milling process. The use of a dry powder form of particles is advantageous for this method of surface-treating macroscopic particles because the dry form provides additional flexibility in both the ratio and selection of macroscopic and inorganic particles. Another advantage of this method is that the dry form of particles may be prepared for a wide variety of different cosmetic or dermatologic applications which may require a specific moisture level.

Mechanofusion is a highly intensive co-processing milling system that uses mechanical energy to fuse a guest particle onto a host particle to form a new material. As used herein, the host material is the macroscopic particle, while the guest material is the inorganic particle. Mechanofusion is a dry coating process that provides a relatively complete ultra-thin coating of guest materials onto host materials by applying high shearing and/or impaction forces. In this embodiment, a nanometer thick coating of small, hard inorganic guest particles are fused onto large, but soft macroscopic host particles to create surface-treated macroscopic materials that have a coating of inorganic particles on the surface of or the inorganic particles are embedded on the macroscopic particles.

Briefly, the mechanofusion method involves the steps of: a) combining inorganic particles and macroscopic particles, and optionally other ingredients; b) simultaneously generating compression and shear forces; c) applying the compression and shear forces to the inorganic particles, macroscopic particles, and any additional ingredients; and d) embedding the inorganic particles onto the surface of the macroscopic particles, thereby forming surface-treated macroscopic materials.

Mechanofusion is achieved by applying compressive and shear forces to the combination of inorganic and macroscopic particles that are combined in, for example, any commercially available mechanofusion machine, such as the product sold by Hosokawa Micron, Ltd® (Osaka, Japan) under the tradename HOSOKAWA MICRON MECHANOFUSION SYSTEM® AMS-Mini™. Some mechanofusion mixers have, for example, a rotating outer vessel, a stationary inner piece with rounded blades, and a stationary scraper, which can be made of either ceramic or stainless steel. Some other mechanofusions have a sample chamber with rotating blades. Other mixers which can achieve the same compressive and shear forces and behave similarly to mechanofusion machines to result in surface-treated macroscopic material compositions through mechanofusion are also contemplated.

After placing a specific measured amount of macroscopic and inorganic particles into the vessel, the vessel is rotated at very high speeds, typically between 200-5000 revolutions per minute (RPM). The gap between the blades and/or the vessel may be adjusted to vary the mixing energy delivered to the particles or powder blend. The shear and compressive forces generated are a function of sample loadings measured by percent by volume (vol. %), gap between the blades and/or the vessel, and the revolutions per minute (RPM). Compressive and shear forces sufficient for embedding inorganic particles on the surface of macroscopic particles can be achieved in, for example, a HOSOKAWA MICRON MECHANOFUSION SYSTEM® AMS-Mini™ by having a particle loading between about 8 to about 60 (vol. %) with an RPM ranging from about 500 to about 3000 RPMs for about 20 minutes to about 3 hours, more preferably at about 1600 RPMs for about 40 minutes. Similar parameters are useful in other types of mechanofusion systems. Practitioners understand how to calculate and modify the parameters accordingly.

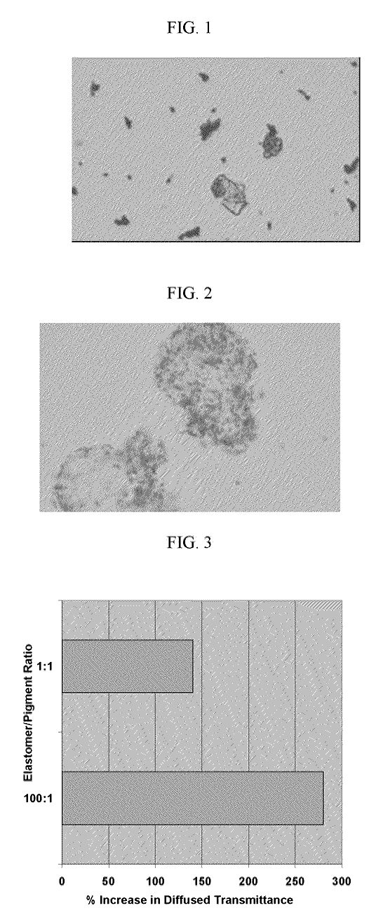

While rotating in the mechanofusion machine, the particles pass through a gap between the vessel and blades and as a result, the particles are subjected to intense shearing and compressive (impaction) forces that are sufficient to embed the inorganic particles on the surface of macroscopic particles. These forces mechanically induce surface reactions to “fuse” or embed the inorganic particles onto the surfaces of the macroscopic particles. Furthermore, the shear forces are strong enough to break apart inorganic particle aggregates, thus the use of aggregates of inorganic particles are envisioned as part of the embodiment. For example, pigment aggregates, such as those shown in FIG. 1, break apart into individual pigments or smaller aggregates (see, FIG. 2), allowing the hard inorganic particles to fuse to the surface of the softer matrix of the macroscopic particle.

In one embodiment, all of the ingredients of a composition, i.e., the macroscopic particles, the inorganic particles, such as pigments, pigment blends, and fractal particles, or other ingredients desired in the preparation of a cosmetic or dermatologic composition are first placed into a sample chamber of a mechanofusion machine. Second, the sample chamber is closed and the speed and time are set. Third, the blades spin or the outer vessel of the mechanofusion machine rotates, which simultaneously generates sufficient compression and shear forces. These forces are applied to the inorganic particles, macroscopic particles, and additional ingredients, breaking the aggregates apart and embedding the inorganic particles on the surface of the macroscopic particles, thereby forming a surface-treated macroscopic material composition.

Generally, the rotations per minute (RPM) setting of the blades or rotating outer vessel is inversely proportional to the running time. For example, the lower the RPM setting, the longer the time required for the mechanofusion machine to run, and vice versa. It is to be understood that the mechanofusion speed and time settings may be varied as the skilled artisan in the field would know and understand. In a preferred embodiment, the inorganic and macroscopic particles, as well as any other ingredients, are blended at about 500 to about 3000 RPMs for about 20 minutes to about 3 hours, more preferably at about 1600 RPMs for about 40 minutes, or until the inorganic particles are embedded on the surface of the macroscopic particles and remain in place.

In general, this process preferably works if there is a differential in the relative particle sizes and their hardness. In a preferred embodiment, hard, sub-micron inorganic particles having a JIS A value of 90 or greater and between about 0.1 to about 5 microns in diameter are combined with soft macroscopic particles having a JIS A value of less than 90 and about 1 to about 100 microns in diameter, preferably about 1 to about 20 microns. Preferably, the inorganic particles have a shorter diameter than that of the macroscopic particles. For example, an inorganic particle, such as titanium dioxide or fumed silica, having a diameter of about 0.1 to about 5 microns may be combined in the mechanofusion chamber with soft macroscopic particles of at least about 1 micron in diameter, preferably about 2 to about 20. The shear forces are sufficient to break apart inorganic particle aggregates, thus pigment aggregates, for example, may be added to the mechanofusion chamber without detriment to the ultimate product, i.e., the desired macroscopic particle surface embedded with inorganic particles. The ratio of the diameters of the macroscopic particle to that of the inorganic particle is between about 1 to about 1000, more preferably about 10 to about 100 and most preferably between about 20 to about 50. The ratios of macroscopic particle diameter to the inorganic particle diameter are chosen to achieve a close packed arrangement of the inorganic particle on the surface of the macroscopic particle.

Table 1 of Example 1 provides non-limiting examples of formulations of the ingredients and amounts thereof in percent ranges by which inorganic particles may be useful in treating macroscopic particles through mechanofusion. All amounts are in percentages of overall composition by weight. Some embodiments include a surface-treated macroscopic material of about 30-90% macroscopic particles, about 0-70% pigment or pigment blends, and about 0-50% fractal particles (see, Table 1). The inorganic particles useful in surface-treated macroscopic materials may have pigments or pigment blends alone, and/or fractal particles embedded on the surface of macroscopic particles.

In another embodiment of the invention, the inventive composition may be prepared by treating macroscopic particles with inorganic particles through physical adsorption from solution. In solution, the inorganic particles adsorb onto the surface of the macroscopic particles and are held together by, but not limited to, capillary forces, Van der Waals forces, polar interactions (i.e., hydrogen bonding), or combinations therein. This attachment occurs when the inorganic particle and macroscopic particle have similar surface energies. The adhesion of the inorganic particles to the rough grooves of the macroscopic particle surface are thermodynamically and kinetically favorable if the solvent has a different surface energy to either the inorganic particle or macroscopic particle.

Briefly, the physical adsorption method involves the steps of: a) combining macroscopic particles, inorganic particles, and optionally other ingredients with a suitable solvent where the surface energy of the macroscopic particle is similar to the surface energy of the inorganic particle and yet their surface energies are significantly different from the surface energy of the solvent; and b) embedding the inorganic particles and/or other ingredients as desired on the surface of the macroscopic particles.

In a preferred embodiment, the difference in surface energy of the combination of the inorganic particle and macroscopic particle should similarly be less than 1 dyne/cm² and the solvent (continuous phase) should be greater than 1 dyne/cm². One skilled in the art can calculate the surface energies by determining the contact angle measurements with, for example, a goniometer (F. Etzler, “Surface free energy of solids: a comparison of models”, Contact Angle, Wettability and Adhesion, Vol. 4: 215-236 (2006); P. Reynolds, “Wetting of Surfaces”, Colloid Science: Principles, Methods, and Applications, 159-179 (Terrence Cosgrove ed., Blackwell Publishing) (2005); D. Y. Kwok and A. W. Neumann, “Contact angle measurement and contact angle interpretation,” Advances in Colloid and Interface Science, Vol. 81, No. 3: 167-249(83) (1999); Frank W. Delrio et al., “The role of Van der Waals forces in adhesion of micromachined surfaces,” Nature Materials, Vol 4: 629-634, August 2005, published online Jul. 17, 2005; Libor Kvitek et al., “The study of the wettability of powder inorganic pigments based on dynamic contact angle measurements using Wilhelmy Method,” Chemica Vol. 4: 27-35 (2002); Gary E. Parsons et al., “The use of surface energy and polarity determinations to predict physical stability of non-polar, non-aqeuous suspensions,” International Journal of Pharmaceutics, Vol. 83: 163-170 (1992); E. D. Shchukin, et al., “Adhesion of particles in liquid media and stability of disperse systems,” Colloids and Surfaces, Vol. 2: 221-242 (1981); each of which are incorporated herein by reference).

Likewise, one skilled in the art can alter the surface energy of macroscopic particles and/or surface energy of inorganic particles, such that the surface energies of the macroscopic particles and the inorganic particles are matched, by using appropriate chemistries to treat the surface of the particles. Useful surface modification chemistries include, but are not limited to, silane treating agents, ozonolysis, adsorption of polymeric species, and the like. The surface energies are a function of a contact angle and in a preferred embodiment, the contact angle between the solvent and particles—either macroscopic or inorganic—is between about 60° and about 120°, more preferable between about 70° and about 110°, and most preferable between about 80° and 105°.

In a preferred embodiment, the macroscopic particles should be rough and exhibit a substantially grooved or porous surface in which the selected inorganic particles can fit. In another preferred embodiment, the interaction between the solvent and the inorganic particle should be chosen by one skilled in the art so that the inorganic particles are drawn into surface grooves or pores of the macroscopic particles by capillary forces.

In one embodiment, the physical adsorption method preferably uses sub-micron sized pigments, i.e., less than about 1 micron, preferably less than 0.8 microns combined with large sized macroscopic particles, i.e., greater than about 10 microns, and preferably greater than 20 microns as measured by their diameters. For example, a hydrocarbon modified silicone crosspolymer product sold by Momentive Performance Materials (Fairfield, Conn.) under the tradename VELVESIL™ 125 silicone copolymer network (hereinafter, “silicone copolymer network”) dispersed in a cyclo-pentacyclomethanone solvent with alkyl-silane treated TiO₂ results in the surface treatment of alkyl silane-treated TiO₂ on the silicone copolymer network. This occurs because the alkyl-silane treated-TiO₂ and silicone copolymer network have similar properties relative to the solvent to form a surface-treated macroscopic particle. Not to be bound by theory, but in a thermodynamically and kinetically favorable interaction, the alkyl silane treated-TiO₂ inorganic particles and the silicone copolymer network macroscopic material adhere to each other by capillary forces. Upon partial removal of the solvent, the alkyl silane treated-TiO₂ and the silicone copolymer network remain held together by capillary forces or mechanical surface tension forces. Upon complete removal of the solvent, the particles may remain held together by Van der Waals forces or polar interactions, such as, for example, hydrogen bonding.

In yet a further embodiment of the invention for a method of preparing the inventive composition, the inorganic particles are embedded on the surface of macroscopic particles by pie-emulsifying a mixture of self-curing elastomer (macroscopic particle) in a suspension of inorganic particles. Briefly, this occurs by the following steps: (a) mixing a pre-polymer, a curing agent, and a cross-link initiator catalyst; (b) emulsifying the mixture from step (a) in a silicone emulsifier; (c) agitating the emulsification from step (b); (d) adding a suspension of water and an inorganic particle to the emulsification of step (c); and (e) stirring the product of step (d) thereby embedding the inorganic particle on the surface of the macroscopic particle.

First, the pre-emulsion mixture must be formed by combining the pre-polymer, a cross-link initiator catalyst, and a curing agent. The pre-polymer includes such products typically used to form macroscopic particles, such as, but not limited to, butyl rubber, halogenated butyl rubbers, polybutadiene, nitrile rubber, and VELVESIL™ 125. The chemical structure of a pre-polymer is a siloxane polymer with at least two alkenyl-functionalized terminal groups or alkenyl functionalized side chains. The cross-link initiator catalyst initiates the formation of cross-links between different polymeric chains of the macroscopic polymer. The curing agent is a molecule or compound that provides a hydrosilane functional group which can undergo addition reaction with the alkenyl functionalized siloxane prepolymer in the presence of a metal catalyst.

The catalyst may be any catalyst capable of affecting the addition reaction. Preferably, the catalyst is one which is capable of initiating the addition reaction below body temperature so as to achieve rapid cross-linking (i.e., about 5 seconds to about 5 minutes). Group VIII metal catalysts, including cobalt, platinum, ruthenium, rhodium, palladium, nickel, osmium, and iridium catalysts, are contemplated to be suitable for the practice of the embodiment. Preferably, the catalyst is a platinum, rhodium, or palladium catalyst. More preferably, the catalyst is a platinum catalyst, including but not limited to, chloroplatinic acid, platinum acetylacetonate, complexes of Pt(II) with olefins, Pt(0) complexes with phosphines, PtO₂, PtCl₂, PtCl₃, Pt(CN)₃, PtCl₄, H₂PtCl₆.6H2O, Na₂PtCl₄.4H₂O, PtCl₂-olefin complexes, H(PtCl₃-olefin) complexes, hexamethyldiplatinum, Pt(0)-vinylsiloxanes, Pt(0) catalysts such as Karstedt's catalyst, platinum-alcohol complexes, platinum-alkoxide complexes, platinum-ether complexes, platinum-aldehyde complexes, platinum-ketone complexes, and the like. Suitable rhodium catalysts include, but is not limited to, rhodium complexes such as rhodium(III) chloride hydrate, and RhCl₃(Bu₂S)₃. Other hydrosilylation (addition) catalysts are described in, for example, U.S. Pat. Nos. 6,307,082; 5,789,334; 4,681,963; 3,715,334; 3,715,452; 3,814,730; 3,159,601; 3,220,972; 3,576,027, and 3,159,662, all of the disclosures of which are hereby incorporated by reference.

In one embodiment, the ratio of pre-polymer and curing agent is chosen so that the cross-linking reaction takes approximately 30 minutes to about 1 hour as one of skill in the art would be acquainted with the time a cross-linking reaction requires at various ratios of pre-polymer and curing agent. For example, a ratio of 1 part pre-polymer to 0.15 part cross-link initiator in 3 parts volatile solvent such as methyl trimethicone will result in a free flowing low viscosity liquid for about 20 minutes and will solidify in about 30 minutes. In this example, the methyl trimethicone is a volatile silicone which is compatible with the pre-polymer-initiator system. The volatile solvent is not absolutely required in this reaction, but rather it acts as a diluent and is needed to adjust the concentration of pre-polymer or cross-link initiator catalyst which controls the reaction rate. The curing agent, however, is a required ingredient.

Secondly, the mixture of pre-polymer, cross-link initiator catalyst, and curing agent must be emulsified by using a suitable silicone emulsifier and agitated to form emulsified particles. As used herein, non-limiting examples of silicone emulsifiers include molecules and compositions that form silicone vesicles to ease delivery thereof in a cosmetic solution. Such silicone emulsifiers include, but are not limited to, lauryl PEG/PPG-18/18 methicone, cyclopentasiloxane (and) PEG/PPG-18/18 dimethicone, cyclopentasiloxane (and) PEG-12 dimethicone crosspolymer, PEG-12 dimethicone, and cyclopentasiloxane (and) PEG/PPG-19/19 dimethicone. Such products include, but are not limited to, such product as those sold by Dow Corning® (Midland, Mich.) under the tradenames DC 5200™, DC-5225C™, DC 9011™, DC 5329™, DC 5330™ emulsifier, and DC BY 11-030™.

In a preferred embodiment, the pre-emulsion mixture and silicone emulsifier are agitated for approximately 1-10 minutes, most preferably for approximately 5 minutes at 300 RPMs using a lab overhead stirrer equipped with a 3-blade mixing propeller.

Finally, a suspension of inorganic particles in water is added to form emulsion droplets and stirred to ensure that the emulsion particles have solidified through cross-linking reactions to form surface-treated macroscopic particles. In a preferred embodiment, the mixture is stirred for approximately 30 minutes to 1 hour, most preferably for approximately 45 minutes.

In another embodiment, the pre-polymer mixture may be introduced into a microfluidic apparatus to produce compositions of an inorganic particle surface-treated macroscopic material in shapes other than spheres, such as but not limited to, rectangles, disks, wafer, and lens. The inventive compositions of surface-treated macroscopic material may be shaped in any format which may be useful in the preparation of cosmetic or dermatologic compositions. These shapes may preferably selected to increase the versatility of the final product composition and its use, such as different dermatological applications with increased skin feel and wear benefits.

In a preferred embodiment, the pre-polymer is added in one end of the microfluidic device while the inorganic particles dispersed in water are added from the other. The pre-polymer and inorganic particles form emulsion droplets and undergo cross-linking to form particle-coated elastomers.

Compositions of surface-treated macroscopic materials as prepared by any of the aforementioned methods may have many useful applications. Although the inventive compositions may apply to any technical field, one embodiment of the invention relates to compositions of the surface-treated macroscopic material in the cosmetic and dermatological fields. The composition embodiments of the invention, however, are well-suited for any topical applications, including but not limited to, foundations, pressed powders, concealers, eye shadows, medical applications, body paint, artistic paints, industrial paints, and dyes.

The inventive compositions as used in a cosmetic or dermatological application are useful in providing coverage and optical blurring. Skin imperfections or textural imperfections, such as but not limited to, wrinkles, fine lines, scars, and the like on a biological surface may be blurred or appear lessened upon application of the inventive composition. Cosmetics of the inventive composition include make-up, foundation, skin care products, and hair products. Make-up includes, for example, products that leave color on the face or alter the appearance of biological surfaces, including foundation, blacks and browns, i.e., mascara, concealers, eye liners, brow colors, eye shadows, blushers, lip colors, powders, solid emulsion compact, and so forth. Skin care products are those used to treat or care for, or for example, moisturize, improve, or clean the skin. Products contemplated by the phrase “skin care products” include, but are not limited to, adhesives, bandages, occlusive drug delivery patches, nail polish, powders, shaving creams, anti-wrinkle or line-minimizing products and the like. Foundations include, but are not limited to, liquid, cream, mousse, pancake, compact, concealer or like products created or reintroduced by cosmetic companies to even out the overall appearance and/or coloring of the skin. Medical applications are those products used in the medical, pharmaceutical, and dermatological fields. Paints include those products used to color materials other than biological surfaces, such as human skin. Exemplary paints made of the inventive composition may be useful in industrial, artistic, or other commercial settings. Dyes include soluble or insoluble coloring solutions. Body paints are those products that color the skin of a human or animal, but are not considered as a make-up or other cosmetic, such as products used to color skin for military, artistic, religious, or cultural purposes.

In another embodiment of the invention, the inventive composition including surface-treated macroscopic materials may be combined with various ingredients to formulate a cosmetic or dermatological composition, or industrial composition, in another embodiment of the invention. Non-limiting examples of ingredients are presented in percentages of overall composition by weight. The surface-treated macroscopic material may be combined with some or all of these exemplary ingredients: water (0-38.8%), silicone copolymer network (10-25%), D5 cosmetic grade silicone base fluid (8-21%), isododecane (3-10%), SF 63 (0-3%), pigment blend-treated elastomer (7-14%), fumed alumina- or fumed silica-treated elastomer (3-10%), Dow Corning 1413 Fluid (2-15%), Dow Coming DC9021 (0-10), nylon (0-7), thickening agent (0-4), other pigments (0-3), and NaCl (0-0.2) for the preparation of a cosmetic composition of the invention presented herein.

The composition embodiment of the invention can be used in cosmetic or dermatological applications to reduce the appearance of textural imperfections and blemishes. In one embodiment, the cosmetic or dermatological composition is applied directly onto surfaces, such as keratinous or biological surfaces like the skin. The composition may be applied onto these exemplary surface by using hands, cotton swabs, sponges, or cosmetic brushes to spread the composition onto the skin, for example. In another embodiment, the cosmetic or dermatological composition may be applied daily, every other day, or whenever desirable, before or after cleaning the specific area of skin, depending on the intended use. The practitioner would appreciate the routine and technique for applying such compositions and as needed.

The topical cosmetic or dermatological composition is preferably applied at least once daily, and is applicable to the face, neck, or body. Applications may be applied anywhere in need of aesthetic improvement where the composition remains on the skin, and is preferably not removed or rinsed off the skin until desired. The cosmetic or dermatological composition is applied as a thin film on a keratinous surface. The film preferably has a thickness of about 2 microns and 50 microns.

The present invention offers a number of advantages. First, the inorganic particles treated on the surface of macroscopic particles do not migrate on surfaces into, for example, skin pores, fine lines, and wrinkles. Even over time, these surface-treated material compositions will not accentuate fine lines, imperfections, defects, or blemishes, providing excellent coverage and blurring. By embedding inorganic particles on the surface of macroscopic particles, the effective size of the inorganic particles increases and reduces the surface migration and collection of inorganic particles which commonly occurs with small sub-micron sized inorganic particles. Likewise, as one skilled in the art would know, fractal particles embedded on the surface of macroscopic particles lower the mobility of the macroscopic particles by absorbing excess oils that enable mobility.

Second, the methods of treating macroscopic particle surfaces with inorganic particles described herein allow increased spatial distribution of inorganic particles, such as but not limited to pigments, on the surface of the macroscopic particles. The increase in spatial distribution optimizes backscattering and reduces the appearance of imperfections by enhanced forward and lateral light scattering, covering, for example, damaged skin, wrinkles, and blemishes, resulting in a natural appearance.

Third, the invention achieves a good balance of maintaining a natural appearance while simultaneously reducing both color imperfections and textural imperfections. Blending soft focus materials with high opacity pigments neutralizes the effectiveness of soft focus materials by both enhancing backscattering and reducing diffused transmittance. The inventive compositions use less pigment or none, thereby reducing their neutralizing effect on the color appearance of the applied composition as a whole.

Fourth, inorganic particle surface-treated macroscopic materials have a greater blurring efficiency as compared to untreated macroscopic particles. Embedding macroscopic particles with higher refractive index particles, for example either pigments or fractal particles, have been found to increase blurring efficiency compared to untreated macroscopic particles. This is demonstrated, for example, by the increase in diffused transmittance as shown in FIG. 3. For instance, embedding a higher refractive index inorganic particle on the surface of a macroscopic particle induces a differential in the refractive index, thus enhancing the light bending properties of a treated macroscopic particle. The differential in refractive index is induced at the interface between the macroscopic particle core and the surface of the macroscopic particle embedded with inorganic particles, which bends light as it passes through the interface.

Another embodiment of the invention encompasses compositions of the surface-treated macroscopic material comprising a cosmetically or dermatologically acceptable formulation which is suitable for contact with living mammalian tissue, including human tissue, or synthetic equivalents thereof, with virtually no adverse physiological effect to the user. Compositions embraced by this invention, i.e., having a macroscopic particle and inorganic particle embedded or treated thereon, may be provided in any cosmetically and/or dermatologically suitable form. Non-limiting examples include compositions prepared as a lotion or a cream, but also in an anhydrous or aqueous base, as well as in a sprayable liquid form. Other suitable cosmetic product forms for the compositions of this invention include but are not limited to, for example, an emulsion, a balm, a gloss, a foam, a gel, a mask, a serum, a toner, an ointment, a mousse, a pomade, a solution, a spray, or a wax-based stick. In addition, the compositions contemplated by this invention can include one or more compatible cosmetically acceptable adjuvants commonly used and known by the skilled practitioner, such as fragrances, emollients, humectants, preservatives, vitamins, chelators, thickeners, perilla oil or perilla seed oil (such as those described in publication no. WO 01/66067, “Method of Treating a Skin Condition,” incorporated herewith) and the like, as well as other botanicals such as aloe, chamomile, and the like. Pigments, dyes, and colorants and the like, would be useful for enhancing the optical blurring and reflective properties of the composition.

The contents of all patents, patent applications, published PCT applications and articles, books, references, reference manuals and abstracts cited herein are hereby incorporated by reference in their entirety to more fully describe the state of the art to which the invention pertains.

As various changes can be made in the above-described subject matter without departing from the scope and spirit of the present invention, it is intended that all subject matter contained in the above description, or defined in the appended claims, be interpreted as descriptive and illustrative of the present invention. Many modifications and variations of the present invention are possible in light of the above teachings.

### EXAMPLES

The following non-limiting examples illustrate particular embodiments and specific aspects of the invention to illustrate the invention and provide a description of the present invention and methods for those skilled in the art. The examples are not necessarily meant to be comprehensive of the entire scope of the invention. The examples should not be construed as limiting the invention, as the examples merely provide specific compositions and methodologies useful in the understanding and practice of the invention and its various aspects.

### Example 1

### Preparation of Surface-Treated Macroscopic Material by Mechanofusion

### General Procedure

Various sample formulations of surface-treated macroscopic materials made of the ingredients and combinations illustrated in Table I were loaded in the sample mechanofusion chamber of a HOSOKAWA MICRON MECHANOFUSION SYSTEM® AMS-Mini (Hosokawa Micron Ltd; Osaka, Japan). Each sample formulation was run in the sample mechanofusion chamber at 1600 RPM for 20 minutes at about 25-30° C. Afterwards, the sample mechanofusion chamber was inspected to ensure that all particles were in the main mixing chamber. Finally, the sample was mixed for a second time at 1600 RPM for 20 minutes at about 25-30° C.

Using the above procedure, compositions or formulations shown in Table I were prepared including the surface-treated macroscopic materials. All amounts are in percent by weight.

TABLE I

| Ingre- | Formulations: | | | | | | | | |
|---|---|---|---|---|---|---|---|---|---|
| dients | 1 | 2 | 3 | 4 | 5 | 6 | 7 | 8 | 9 |
| Macro- | 90 | 70 | 60 | 40 | 30 | 50 | 60 | 70 | 70 |
| scopic | | | | | | | | | |
| material | | | | | | | | | |
| Pigment | 10 | 30 | 40 | 60 | 70 | 0 | 0 | 0 | 0 |
| Blend | | | | | | | | | |
| Fumed | 0 | 0 | 0 | 0 | 0 | 25 | 20 | 15 | 10 |
| Alu- | | | | | | | | | |
| mina | | | | | | | | | |
| Fumed | 0 | 0 | 0 | 0 | 0 | 25 | 20 | 15 | 20 |
| Silica | | | | | | | | | |
| Total % | 100 | 100 | 100 | 100 | 100 | 100 | 100 | 100 | 100 |
| of | | | | | | | | | |
| weight | | | | | | | | | |

### Example 2

### Preparation of Surface-Treated Macroscopic Material by Physical Adsorption from Solution

A surface-treated macroscopic material was formed by combining Part A and Part B, both of which are detailed below.

A hydrocarbon modified silicone crosspolymer macroscopic material manufactured by Momentive Performance Materials (Fairfield, Conn.) and sold under the tradename VELVESIL™ 125 was dispersed in (55 wt %) solvent cyclo-pentacyclomethanone D5 (hereinafter, “Part A”) at room temperature using a lab overhead stirrer equipped with a 3 blade mixing propeller for 20 minutes. Alkyl silane treated-TiO₂ (0.2 wt %) inorganic particle was then dispersed in cyclo-pentacyclomethanone D5 solvent (hereinafter, “Part B”) in a separate beaker using a lab overhead stirrer equipped with a 3 blade mixing propeller and mixed at about 400-600 RPM for 20 minutes at room temperature. A pigment surface-treated macroscopic material in gel form was prepared by mixing the hydrocarbon modified elastomer of Part A with TiO₂ of Part B in various weight ratios such that the weight ratio of TiO₂ particles to the macroscopic particles ranges from about 100:1 and about 1:1. Both Part A and Part B can alternatively be mixed at room temperature for 20 minutes using a high shear mixer.

Using the above procedure to prepare samples of pigment-aggregated elastomer gels, the diffused transmittance measurements of which were then taken by using the spectrophotometer manufactured by Gretag-Magbeth (New Windsor, N.Y.) and sold under the tradename COLOR-EYE® 7000 Spectrophotometer in order to determine the soft focus or blurring efficiency. This spectrophotometer can measure films in three modes: total transmittance, direct transmittance, and reflectance. Diffused transmittance is the difference between the direct transmittance and total transmittance.

In these examples, the total transmittance and direct transmittance were measured on each sample. Transmittance was obtained by averaging light intensity between a wavelength of 450 to 700 nm. Each film was measured at three different locations and each measurement was an average of 3 repeat measurements. The diffused transmittance of pigment aggregated macroscopic particles was found to be 140-280% greater than an elastomeric gel control that had no pigment, as shown in FIG. 3. The film of the surface-treated elastomer material had a thickness of 10 microns.

### Example 3

### Preparation of Surface-Treated Macroscopic Material by Pre-Emulsification

A surface-treated macroscopic material was formed by combining Part A and Part B, both of which are detailed below.

Part A, the pre-emulsion mixture, was formed by combining 2.97 g of a commercially available mixture of pre-polymer, cross-link initiator catalyst, and curing agent with 6.95 g of methyl trimethicone in a 50 mL container. Afterwards, 2.47 g of Dow Coming DC 5330 emulsifier was added and the combination was mixed until homogeneous.

Part B was formed by adding 100 mL of water to a 500 mL circular container with an overhead stirrer and a four-blade mixing paddle. Afterwards, 80 mg of dimethicone-treated-TiO₂ (commercially available from Kobo Products, Inc., South Plainfield, N.J.) as added and the entire mixture was vigorously stirred at about 400-600 RPM at room temperature.

Part A was poured into the 500 mL mixing and stirring device containing Part B. This combination was vigorously stirred at about 400-600 RPM for over 1 minute and allowed to continue stirring for about 30 minutes. This produced a surface-treated macroscopic material that was collected as a solid white mass and transferred to a separate container.

All patents and patent publications referred to herein are hereby incorporated by reference.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A composition comprising a macroscopic particle surface-treated with an inorganic particle, wherein the macroscopic particle surface-treated with an inorganic particle has a refractive index greater than a refractive index of a macroscopic particle core of said composition.

2. The composition according to claim 1, wherein the refractive index of the surface to the refractive index of the macroscopic particle core ratio is greater than 1.

3. The composition according to claim 1, wherein the macroscopic particle has a diameter of about 1 to about 200 microns.

4. The composition according to claim 1, wherein the macroscopic particle is a silicone elastomer, a silicone crosspolymer, a polyisoprene, a butyl rubber, a halogenated butyl rubber, a polybutadiene, a nitrile rubber, or combinations thereof.

5. The composition according to claim 1, wherein the inorganic particle is a pigment, said pigment has a diameter of about 0.1 to about 10 microns.

6. The composition according to claim 5, wherein the pigment is TiO₂, iron oxide, ZnO, mica-coated pigments, or combinations thereof.

7. The composition according to claim 1, wherein the difference in refractive indices of the inorganic particle and the macroscopic particle is greater than about 0.1.

8. The composition according to claim 1, wherein the inorganic particle is a fractal particle.

9. The composition according to claim 8, wherein the difference in refractive indices of the fractal particle and the macroscopic particle is greater than about 0.08.

10. The composition according to claim 8, wherein the fractal particle is fumed silica, fumed alumina, fumed TiO₂, or combinations thereof.

11. The composition according to claim 1, wherein the inorganic particle is embedded on a surface of the macroscopic particle by mechanofusion

12. The composition according to claim 11, wherein the macroscopic particle is an elastomeric particle.

13. The composition according to claim 11, wherein the macroscopic particle is a crosspolymer particle.

14. The composition according to claim 1, wherein the inorganic particle is embedded on a surface of the macroscopic particle by physical adsorption.

15. The composition according to claim 1, wherein the inorganic particle is embedded on a surface of the macroscopic particle by a process comprising a) mixing a pre-polymer, a curing agent, and a cross-link initiator catalyst; b) emulsifying said mixture in water and a silicone emulsifier; agitating the combined mixtures of steps (a) and (b); adding a suspension of water and inorganic particle to the combined mixture; and stirring the ingredients.

16. The composition according to claim 15, wherein the silicone emulsifier is lauryl PEG/PPG-18/18 methicone, cyclopentasiloxane, PEG/PPG-18/18 dimethicone, PEG-12 dimethicone crosspolymer, or PEG/PPG-19/19 dimethicone.

17. A method for embedding an inorganic particle on the surface of a macroscopic particle comprising:
(a) combining inorganic particles and macroscopic particles, and optionally other ingredients;
(b) simultaneously generating compression and shear forces;
(c) applying the compression and shear forces to the inorganic particles, macroscopic particles, and additional ingredients, and
(d) embedding the inorganic particles on the surface of the macroscopic particles.

18. The method of claim 17, wherein the macroscopic particle is a crosspolymer.

19. The method of claim 17, wherein the macroscopic particle is an elastomeric particle.

20. The method of claim 17, wherein the shear and compressive forces are applied for a time period ranging from about 20 minutes to about 3 hours.

21. The method of claim 17, wherein the inorganic particle has a JIS A value of 90 or greater and the macroscopic particle has a JIS A value of less than 90.

22. The method of claim 17, wherein the inorganic particles are between about 0.1 to about 5 microns in diameter.

23. The method of claim 17, wherein the macroscopic particles are between about 1 to about 100 microns in diameter.

24. A method for embedding an inorganic particle on the surface of a macroscopic particle, comprising:
(a) combining macroscopic particles, inorganic particles, and optionally other ingredients with a suitable solvent wherein the macroscopic particle has a surface energy similar to a surface energy of the inorganic particle, and either the macroscopic particle surface energy or the inorganic particle surface energy is different from a surface energy of the solvent; and
(b) embedding the inorganic particles or other ingredients as desired on the surface of the macroscopic particles.

25. The method of claim 24, wherein a contact angle between the solvent and macroscopic particle is between about 60° and about 120°.

26. The method of claim 24, wherein a contact angle between the solvent and inorganic particle is between about 60° and about 120°.

27. The method of claim 24, wherein the difference in the surface energies between the inorganic particle and macroscopic particle is less than 1 dyne/cm².

28. The method of claim 20, wherein the difference in the surface energies between the solvent and either the inorganic particle or macroscopic particle is greater than 1 dyne/cm².

29. A method for embedding an inorganic particle on the surface of an macroscopic particle, comprising:
(a) mixing a pre-polymer, a curing agent, and a cross-link initiator catalyst to initiate a cross-linking reaction;
(b) emulsifying the mixture from step (a) in a silicone emulsifier;
(c) agitating the emulsification from step (b);
(d) adding a suspension of water and an inorganic particle to the emulsification of step (c); and
(e) stirring the product of step (d) thereby embedding the inorganic particle on the surface of the macroscopic particle.

30. The method of claim 29, wherein the cross-linking reaction occurs in a period of time ranging from about 30 minutes to about 1 hour.

31. The method of claim 29, wherein the silicone emulsifier is lauryl PEG/PPG-18/18 methicone, cyclopentasiloxane (and) PEG/PPG-18/18 dimethicone, cyclopentasiloxane (and) PEG-12 dimethicone Crosspolymer, PEG-12 dimethicone, or cyclopentasiloxane (and) PEG/PPG-19/19 dimethicone.

32. The method of claim 29, wherein the product of step (a) and silicone emulsifier are agitated for about 1 to about 10 minutes.

33. The method of claim 29, wherein the inorganic particles have a surface energy of about 20 to about 70 dyne/cm².

34. The method of claim 29, wherein the product of step (d) is stirred for about 30 minutes to 1 hour.

35. A method for improving the appearance of a surface, comprising applying the composition of claim 1 on a surface and forming a film that improves the appearance of the surface.

36. The method for improving the appearance of a surface of claim 35, wherein said surface is a keratinous surface, biological surface, synthetic biological surface, skin, hair, or nail.

37. The method for improving the appearance of a surface of claim 35, wherein said composition further comprises water, a silicone copolymer network, a D5 cosmetic grade silicone base fluid, isododecane, a dimethicone gum, a pigment blend-treated elastomer, fumed alumina-treated elastomer, a fumed silica-treated elastomer, polydimethylsiloxane, nylon, thickening agent, other pigments, or NaCl.

38. The method for improving the appearance of a surface of claim 35, wherein the improvement reduces the visibility of textural imperfections of the surface.
